(19) United States
(12) Patent Application Publication
(10) Pub. No.: US 2006/0169178 A1
(43) Pub. Date: Aug. 3, 2006

(54) Civil engineering material and construction method of the same

(76) Inventor: Toshio Hosooka, Misato (JP)

Correspondence Address: OLIFF & BERRIDGE, PLC, P.O. BOX 19928, ALEXANDRIA, VA, 22320, US

(21) Appl. No.: 10/512,142

(22) PCT Filed: Dec. 26, 2002
(86) PCT No.: PCT/JP02/13702

§ 371 Date: Oct. 22, 2004

(30) Foreign Application Priority Data
May 14, 2002 (JP) 2002-138215

(51) Int. Cl. C04B 24/14; C04B 16/00; C04B 14/00; C04B 7/19; C04B 28/08; C04B 7/00

(52) U.S. Cl. 106/656; 106/712; 106/714; 106/733; 106/789; 106/790; 106/811; 106/900

(57) ABSTRACT

The invention aims to provide a civil engineering material effective to suppress heat island phenomenon in urban cities, develop environments matching with the ambient environments of a construction site, and carry out greening of a desert as well as excellent in washing out resistance and/or planting suitability depending on the objects (or purposes) of the civil engineering works and to provide a construction method of the material. The civil engineering material comprises 10 to 40% by weight of water on the basis of extrapolation amount added to a mixture, which includes 0.5 to 10.0% by weight of cement and 90.0 to 99.5% by weight of an aggregate powder containing fine powder with 0.1 mm size or smaller in 10 to less than 50% by weight. In this case, a coloring material and seeds of plants may be previously added.

### TECHNICAL FIELD

The invention relates to a civil engineering material and a construction method of the material, more particularly to a civil engineering material usable for soil amendments for paddy fields as well as land sliding prevention materials in a side walls (finished face) of roads passing along slopes and steep slopes in the ruins of quarries, roadbed materials in flat ground, paving materials, and surface materials and afforestation materials for parking lots, parks, and sports fields such as ball game stadiums, foot ball fields, and the like and a construction method of the civil engineering material.

### BACKGROUND ART

The applicant of the invention previously presented a paving material in Japanese Patent No. 3,080,288 that has resistance to washing out and land-sliding (the property to stand against flowing out by rain water) even if it is used for construction of finished faces of such as steep slopes in the ruins of quarries, roads, and flat ground just like parks and that enables planting and its construction method. Specifically, the applicant previously presented a paving material including 20-40% by weight of water based on 100% by weight of cement-mixed aggregate powder which comprises 0.5-10.0% by weight of cement and 90.0-99.5% by weight of aggregate powder including more than 50% by weight of fine powder 0.1 mm or less in size. The construction method of the material involves curing the foregoing paving material, which is kneaded by a kneader, for 2 to 3 days; and then, loosening the aggregates of the paving material by shifting it to another place at least once; and again curing the material.

The paving material (hereinafter, referred to as Hosolite) is provided with resistance to washing out and land sliding and at the same time planting suitability (easiness to grow plants) and is developed because it enables recycling of the excavated soil generated in an excavation field as an aggregate and thus allows economical construction of roads, repairing works for land-slid sites, and parking lot construction. Accordingly, the fine powder size and the content of the aggregate composing the Hosolite and the addition amount of water are determined based on the above-mentioned applications. The strength between cement concrete and soil was found in Hosolite and places constructed using a construction method of Hosolite such as the finished faces of steep slope walls in the ruins of quarries, roads, and flat ground just like parks. Therefore Hosolite is expected to be sufficiently useful for environmental preservation and disaster prevention.

However, the recent social situation has been changed drastically from those years the Japanese Patent No. 3,080,288 was filed and especially in terms of the living environments, further strict improvements have been required. To say more particularly, it has been an urgent issue to suppress greenhouse effects attributed to CO₂ increase in atmospheric air and heat-island phenomenon in urban cities (the phenomenon in which heat is stored especially in summer and cities become just like high temperature islands since they are composed of civil engineering materials such as concrete, asphalt and the like). Therefore, even if it costs much to deal with such problems, it is desired to provide revegetation on roof and make roads and open ground excellent in the water permeability (easiness of water permeation) and water retention property (easiness of water retention).

On the other hand, there are sites just like parking lots where higher wear resistance is more desired than planting suitability in cities. In such sites, it is desired to use a civil engineering material that is suitable for generating no powder dust even if it is abraded by automobiles or the like and excellent in ventilation, water permeability, water retention property, washing out resistance, and thermal conductivity rather even if it does not have planting suitability and such sites are constructed using the civil engineering material useful for preventing the above-mentioned heat island phenomenon. Also, as illustrated in FIG. 2, it was previously desired that the lower part (about 2 m lower range along the finished face) of a side wall (the finished face) of a road developed by cutting out a slope should have plantability, however in these years, non-planting suitability is preferred in terms of elimination of mowing work, prevention of plants from obstructing traffic, or prevention of firing in mountain. Moreover, since the appearance is not good if the concrete is used, it is desired for such a part to have color well matching with the ambient environments. Also, it is desirable to re-use the debris flow for the aggregate of Hosolite in a site where the debris flow occurs, however in the case of the conventional Hosolite, there is a problem that the fine powder contained in the aggregate has too large particle size and therefore, the repairing work cannot be carried out as desired.

In addition, as a series of countermeasures against recent global warming, there is an issue of greening a desert and presently, mainly nursery trees and trees are planted in dug out holes in a desert. However, the soil of the desert has good water permeability but no water retention capability. Also, in terms of the weathering condition, not only the water evaporation is high but also the embedded soil is blown out by strong wind and the roots of plants are exposed to the surface and thus the nursery plants and plants can hardly grow in the present situation.

In such a situation, the invention aims to provide a civil engineering material that not only has excellent washing out resistance and/or planting suitability but also is effective for suppressing heat island phenomenon in urban cities and for producing environments matching with the surrounding of a work site and carrying out greening of a desert depending on the object (or the purpose) of the civil engineering work and to provide a construction method using the material.

### DISCLOSURE OF THE INVENTION

In view of the above circumstances, the inventor has reviewed the paving material and its construction method disclosed in Japanese Patent No. 3,080,288 and has embodied resulting outcome in the present invention.

The present invention provides a civil engineering material comprising 10 to 40% by weight of water on the basis of extrapolation amount added to a mixture, which comprises 0.5 to 10.0% by weight of cement and 90.0 to 99.5% by weight of an aggregate powder including 10 to less than 50% by weight of fine powder with 0.1 mm or smaller in size. In this case, it is preferable to mix one or more types selected from iron oxide, granulated blast slag, steel refining slag and artificial coloring materials all in form of granules with the mixture. Or it may be preferable to mix seeds of plants and/or fertilizers with the mixture.

The present invention also provides a construction method of the civil engineering material comprising the steps of;

kneading the civil engineering material; curing the material for 8 to 48 hours; loosening the agglomerates of the hardened material at least once; and curing again the material by applying a prescribed pressure at a working site.

The present invention further provides a construction method of the civil engineering material comprising the steps of; kneading the civil engineering material; curing the material for 8 to 48 hours; loosening the agglomerates of the hardened material at least once; loading the material in a frame and curing again the material by applying a prescribed pressure at a working site for forming a container-like formed body; and digging a hole at a working site and embedding the formed body in the inside of the hole so as to nurture a plant and/or tree in the formed body. In this case, the container-like formed body is preferably a planter or the working site is preferably in a desert.

According to the invention, land sliding in a sidewall of a road developed by cutting out a sloping land or in a quarry can be prevented. Besides heat island phenomenon in urban cities can be suppressed, environments matching with the surrounding of a construction site can be produced and greening of a desert is possible.

### BRIEF DESCRIPTION OF THE DRAWINGS

FIG. 1 is a graph showing the correlation between a dry density and the water content of a civil engineering material of the invention;

FIG. 2 shows a road developed by cutting out a sloping land; and

FIG. 3 shows a civil engineering work example in the case of greening of a desert and FIG. 3(a) shows a case of embedding one formed body in one hole and FIG. 3(b) shows a case of embedding a large number of formed bodies in one hole.

### BEST MODES FOR CARRYING OUT THE INVENTION

Hereinafter, the embodiments of the invention will be described with reference to the background of the accomplishment of the invention.

Inventors of the invention at first assumed that if a material has washing out resistance and good ventilation property, water-permeability, water retention property and thermal conductivity, the material is effective for suppressing heat island phenomenon even if it does not have planting suitability since water evaporation heat can be used. The material can be applied, for example, for parking lots in cities, malls of public parks, and lower parts of sidewalls of roads developed by cutting out sloping lands. On the basis of investigations carried out at the time of invention of the above-mentioned conventional Hosolite, inventors reminded the finding that plantability could be reduced by increasing the secondary generation of strength of a hydraulic material to a certain value after it became hardened by curing (called as the plant growth limit strength, e.g. about 14.0 N/cm²). According to the common knowledge in the civil engineering technology, decreasing the water content in the material, adding no fine powder to the aggregate, or increasing the amount of cement will increase the secondary generation of strength. Also, it is supposed possible to utilize the hydration reaction of cement as the principle of development of the strength, similarly to the case of the above-mentioned Hosolite, even if the particle size of the aggregate becomes small.

Based on these discussions, inventors have continued with a study by using portland cement as the cement and a fine powder for the aggregate and adding 20 to 40% by weight of water as extrapolated weight. And it was found that if 50% by weight or more of aggregate containing a fine powder with 0.1 mm or smaller is used just like the conventional Hosolite, it is difficult to keep the secondary generation of strength of the material after hardening by curing at the above-mentioned plant growth limit value or higher. This is presumably because of excessive amount of fine powders and water.

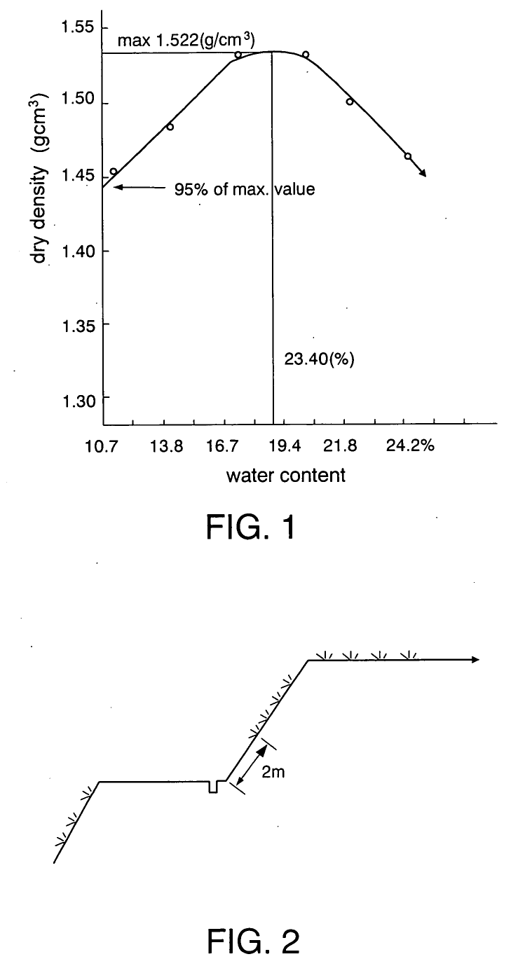

Therefore, the study was further continued, by decreasing the amount of the fine powder with 0.1 mm or smaller to a range of 10 to less than 50% by weight. It was found that the secondary generation of strength could reach the plant growth limit or higher even if the water content was less than 20% by weight. A number of tests were conducted by changing a type of aggregate as it will be described later until it was confirmed that same results could be obtained in any case to accomplish the invention. In this case, the secondary generation of strength is measured according to Concrete test method of JIS (JIS A1108) using a hydration-aged column test specimen (height: 150 mm and diameter: 50 mmφ). The correlation between the water content and the dry density of a test specimen is shown in FIG. 1, and from the value of the dry density, obviously the secondary generation of strength exceeds the plant growth limit strength. This is because the results shown in FIG. 1 satisfy the standard according to the restriction related to “Soil tightening and hardening of surplus soil,” stating that if the dry density is 95% or higher of the maximum dry density value, the material is available for practical use. However, if the water content is less than 10% by weight, the material becomes same as conventional cement concrete and if the water content is more than 40% by weight, the solidification becomes insufficient and the washing out resistance is considerably decreased and therefore, the amount of water to be extrapolated is defined in a range of 10 to 40% by weight. Further, if the amount of the fine aggregate powder of 0.1 mm or smaller becomes less than 10% by weight, the material becomes just like cement concrete. Therefore the above ranges were excluded from the present invention.

As the aggregate to be used in the invention, those which properly contain SiO₂ and CaO effective for pozzolanic reaction can be used and soil in a work field, incinerator ashes of industrial wastes, and slag generated by incineration as well as sand and earth are exemplified. As the cement, commercialized cement other than portland cement and so-called self-made ones from granulated blast furnace slag, gypsum, lime, fly ashes may be used.

Inventors have made further investigations as to whether the materials can be matched with the color in the ambient environments. Accordingly, inventors have found that substances and their powders coloring with the following characteristics may be selected or mixed and the materials obtained by mixing such substances are also claimed as the invention. It is because paving with longer-lasting coloration is possible as compared with paving colored by spraying a painting material to the surface.

For example, it is effective to use a hematite ore (ferric oxide) for red type coloration, a magnetite ore (ferrous oxide) for black type coloration, and granulated blast furnace slag. Also, colored artificial stones and artificial coloring materials such as plastics and their crushed debris can be used for coloration adjustment in a wide range. The addition amounts of these substances may be adjusted in an actual work field in a try and error manner or as previously planed and determined.

Investigation was also conducted on the construction method in a place where plantability of the civil engineering material is required to a certain extent. Since the civil engineering material is provided with a heightened secondary generation of strength by sacrificing plantability, it is required to deal with the countermeasure for the sacrifice. As a result, it is found effective to previously mix seeds of plants and/or fertilizers to the material before the construction and such civil engineering materials are also added to the invention. Also in such a case, the amounts to be added may be adjusted in an actual work field in a try and error manner or as previously planed and determined, similarly to the case of the above-mentioned coloration.

The above-mentioned construction method of the civil engineering material of the invention is as follows. At first, cement and aggregate made ready at the work site or transported from another place are mixed each other and then water is added to the mixture and the resulting mixture is aged for 8 to 48 hours. After that, the agglomerate hardened to a certain degree is loosened by manpower or mechanically. If the curing site and the construction place are different, the obtained material is transported to the construction place, and sprayed (poured) and properly pressurized and left still for curing again. Accordingly, a solidified body with a secondary generation of strength as desired can be obtained by properly adjusting the initial curing time and the degree of the pressure application in the construction place. The reason for defining the initial curing time in a range of 8 to 48 hours is because if it is shorter than 8 hours, the hardness becomes insufficient and if it is longer than 48 hours, the loosening work becomes difficult.

Since the pressurizing degree depends on the types and amounts of the cement and aggregate to be used, and the amount of extrapolated water, it should be previously determined by carrying out a small-scale test.

In this case, an Eirich mixer, a dump truck, and a bulldozer can be used preferably for mixing, transportation, and pressurization, respectively.

Successively, inventors have thought that the civil engineering material of the invention is useful in a variety of places and have made investigations on the construction method for afforestation. As a result, the following method is found effective even in water-permeable soil of such as a desert or the like and the method is also added to the invention.

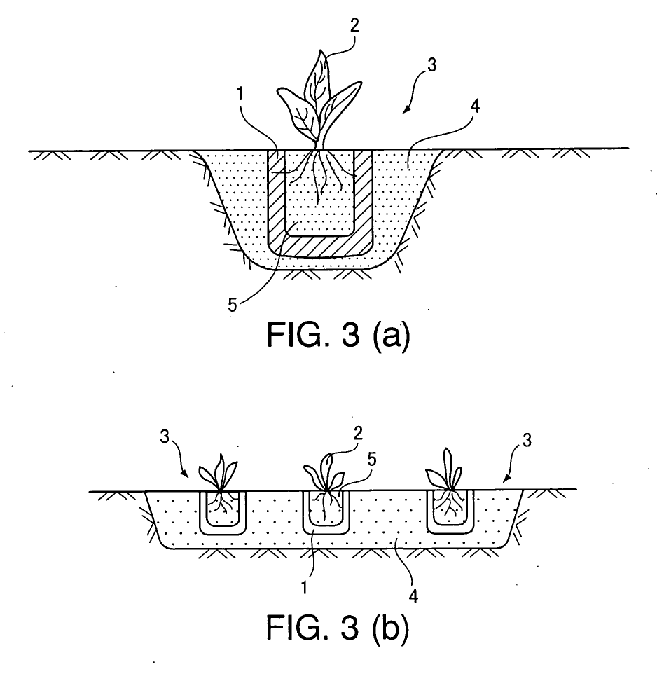

At first, as shown in FIG. 3, the above-mentioned civil engineering material of the invention is mixed, aged for 8 to 48 hours, and the hardened aggregate is loosened at least once and fed to a frame and again aged under a prescribed pressure to obtain a formed body in a container-like form. The reason for that is because if it is tried to grow plants in soil with excessive water permeability, water does not remain in the surrounding of the plants and thus plant growth is suppressed. By using the container made of the above-mentioned material of the invention having water retain-ability, water is surely retained so as to grow plant in a planter.

The container-like formed body 1 is embedded in a hole 3 dug out in the construction place so as to grow plant 2 and/or tree 2.

In such a manner, if it is formed by a proper pressure, the container-like formed body 1 made of the above-mentioned material can be broken by the force of the root of the growing plant 2 since it is not fired and therefore not only root grows freely but also the material is mixed with the surrounding soil 4, resulting in improvement of the soil 4. Accordingly, it is easy to carry out afforestation in the entire region only by digging out a hole 3 even in a land, e.g. a desert, having an immense surface area. At that time, as shown in FIG. 3(b), it is efficient to dig the hole 3 with a huge surface area to embed the formed body therein.

In the present invention, the size and the shape of the container-like formed body 1 is not particularly limited. Because it is important to grow plant and tree 2 in the inside regardless of the shape and size of the formed body. Also, at the time of growing plant and tree 2, no restriction is required for the types of the soil 5 filling the container-like formed body 1. What is required is to produce the formed body by kneading the material containing common soil, sand in a desert, or the same type material as that of the formed body; curing the kneaded material for 8 to 48 hours; and loosening the agglomerate of the hardened material at least once. The same is true for the soil 4 filling the gap between the formed body 1 and the hole 3. It is no need to say that use of the material of the invention is desirable to assure water retention in the surrounding of plants. In addition to that, with respect to the soil 4 filling the above-mentioned formed body 1, not only a single type but also a mixture of several types of soil may be used. It is because the growth of plant and tree 2 can be controlled by adjusting the mixing amounts. Additionally, the construction method has an advantageous point in that a large quantity of the container-like formed bodies 1 may be produced in a place remote from the construction place and planting work can be made easily by transporting them by vehicles. In other words, planting can be carried out economically with high workability.

### EXAMPLE 1

A parking lot with a surface area of 90 m² was constructed by using a civil engineering material of the invention. At that time, the ground was leveled off after the ground was dug shallowly (depth 0.5 m) and the civil engineering material produced by mixing and stirring water 15% by weight as an extrapolated amount with a mixture containing portland cement and aggregate containing 30% by weight of a fine powder with a particle size of 0.1 mm or smaller and curing for 36 hours was laid on the ground and compacted by a road roller. An Eirich mixer was used for mixing cement and adding water.

The construction result was evaluated by sampling a column sample by boring after 21-day curing. The uniaxial compression strength was measured to find the strength as extremely high as 20 N/cm², which is sufficient to use the construction site as a parking lot. Also, in order to investigate the water-permeability and water-retention property necessary to suppress the heat island phenomenon, a water permeability test was carried out. As a result, although plantability was sacrificed, the water-permeability and water-retention property were also found as sufficient as 5.2×10⁻² cm/sec.

### EXAMPLE 2

A mall with a full length of 50 m and a width of 3 m was constructed in a public park by using a civil engineering material of the invention. Also in this case, the ground was leveled after the ground was dug shallowly (depth 0.4 m) and the civil engineering material produced by mixing and stirring water 18% by weight as an extrapolated amount with a mixture containing portland cement and aggregate containing 20% by weight of a fine powder with a particle size of 0.1 mm or smaller and curing for 40 hours was laid on the ground and compacted by a road roller. For the aggregate, granulated blast furnace slag previously adjusted so as to contain 20% by weight of a fine powder with a particle size of 0.1 mm was used to make the coloration white. An Eirich mixer was used for mixing cement with the aggregate and adding water.

Similarly as in Example 1, the construction result was evaluated by sampling a column sample by boring after 21-day curing. The uniaxial compression strength was measured to find the strength as extremely high as 18.2 N/cm², which is sufficient to use the construction site as a mall. Also, to investigate the water-permeability and water-retention property necessary to suppress the heat island phenomenon, a water permeability test was carried out. As a result, although the planting suitability was sacrificed, the water-permeability and water-retention property were also found as sufficient as 8.2×10⁻⁷ cm/sec.

### EXAMPLE 3

Since a road cutting out a slope of a mountain was opened, as shown in FIG. 2, an upper part along the finished face (an inclination angle 45° with respect to the horizontal line) was coated with a conventional Hosolite and the lower part of 2 m distance from the road was coated with the civil engineering material of the invention. In this case, the conventional Hosolite was produced by extrapolating 30% by weight of water to a mixture containing portland cement and aggregate (granulated blast furnace slag) containing 60% by weight of a fine powder with a particle size of 0.1 mm or smaller. The civil engineering material of the present invention was produced by mixing and stirring water in an extrapolated amount of 18% by weight with a mixture containing portland cement and aggregate (dug-out soil) containing 40% by weight of a fine powder with a particle size of 0.1 mm or smaller. To match the color with the ambient environments, the civil engineering material of the invention was mixed with a ferric oxide powder in an extrapolating amount of 4% by weight to intensify the brown color. The construction was carried out by compacting these materials along the finished faces by using a backhoe.

Similarly as in Example 1, the construction result was evaluated by sampling a column sample by boring after 21-day curing and measuring the uniaxial compression strength was measured to find the strength as extremely high as 15.1 N/cm², which is sufficient to use the coating for preventing land-sliding of the slanting ground. Plants had scarcely grown for 1 year in the lower part of the finished face, which showed no mowing work was needed.

### EXAMPLE 4

The ruin with a slanting face (the inclination angle 6°) where debris flow occurred was turned to be a lawn field by using the civil engineering material. At that time, the civil engineering material was produced by adding water in an extrapolated amount of 20% by weight to a mixture containing portland cement and aggregate of the debris flow sieved so as to contain 40% by weight of a fine powder with a particle size of 0.1 mm or smaller and aged at a dew point. After 48 hours, the aged face was once dug out to loosen the agglomerate. Tall fescue Kentucky 31, which is a native rice plant of America, was seeded at the rate of 4 to 5 seeds/cm² in the mixture of the aggregate and cement.

The growth of the lawn is better as the uniting strength of the soil is lower. The root extension is limited more to the surface layer part as the uniting strength is higher. Depending on the type of plants to be grown, the use amount of cement, the water amount and the aggregate particle size should be changed.

### EXAMPLE 5

Similarly to Example 2, water in an extrapolated amount of 18% by weight was added to a mixture containing portland cement and aggregate containing 20% by weight of a fine powder with 0.1 mm or smaller particle size. The obtained mixture was agitated and cured for 40 hours. In order to save cost of the cement, granulated blast furnace slag was used as the aggregate, which had been previously adjusted so as to contain 18% by weight of the fine powder with 0.1-mm particle size. After the hardened material by curing was loosened into granular state by a shovel and packed in a column-like frame and pressurized at about 4.9×10⁵ Pascal to obtain a column-like formed body 1 with an inner diameter 150 mmφ and a thickness 40 mm as shown in FIG. 3(a). A hole 3 with a diameter 500 mm was dug in sandy land of a sea coast to embed the formed body 1 and plant a nursery plant 2 of palm coconut with a height of about 0.3 m. The surrounding of the nursery plant 2 was filled with sand and soil 4, which was used for producing the formed body 1, at the rate of 4:1 to grow the nursery plant. The gap between the formed body 1 and the hole was also filled with the soil 4 used for producing the formed body 1.

As a result, the nursery plant 2 grew successfully to reach as high as 0.5 m even after 4 weeks.

As described above, the invention provides a civil engineering material (also called as Hosolite), which contributes to suppression of heat island phenomenon in urban cities, creates environments matching with the ambient environments of a construction site, and is useful for greening of a desert as well as being excellent in washing out resistance and/or planting suitability depending on the objects (or purposes) of the civil engineering works, and to provide a construction method of the material.

1. A civil engineering material comprising 10 to 40% by weight of the entire material added to a mixture, which comprises:
0.5 to 10.0% by weight of cement; and
90.0 to 99.5% by weight of an aggregate powder including 10 to less than 50% by weight of fine powder with 0.1 mm or smaller in size;
wherein the material is kneaded and cured for 8 hours or more and less than 48 hours forming a hardened material containing agglomerates.

2. The civil engineering material according to claim 1, wherein one or more of granular iron oxide, granulated blast slag, granular steel refining slag, and granular artificial coloring materials is mixed with the mixture.

3. The civil engineering material according to claim 1, wherein seeds of plants and/or fertilizers are mixed with the mixture.

4. A a method for making a civil engineering material comprising the steps of:
loosening agglomerates of the civil engineering amterial of claim 1 at least once;
and curing again the material by applying a prescribed pressure at a working site.

5. A method for making a civil engineering material comprising the steps of:
loosening the agglomerates of the civil engineering material of claim 1 at least once;
loading the material in a frame and curing again the material by applying a prescribed pressure at a working site for forming a container-like formed body; and
digging a hole at a working site and embedding the formed body in the inside of the hole;
wherein the embedded formed body is structurally capable of retaining water and structurally capable of being broken by a force of a root of a plant growing within the embedded container.

6. The method for making the civil engineering material according to claim 5, wherein the container-like formed body is a planter.

7. The method for making the civil engineering material according to claim 5, wherein the working site is a desert.

8. The civil engineering material according to claim 2, wherein seeds of plants and/or fertilizers are mixed with the mixture.

9. A method for making a civil engineering material comprising the steps of:
loosening the agglomerates of the civil engineering material of claim 2 at least once;
and curing again the material by applying a prescribed pressure at a working site.

10. A method for making a civil engineering material comprising the steps of;
loosening the agglomerates of the civil engineering material of claim 3 at least once; and
curing again the material by applying a prescribed pressure at a working site.

11. A method for making a civil engineering material comprising the steps of;
loosening the agglomerates of the civil engineering material of claim 2 at least once;
loading the material in a frame and curing again the material by applying a prescribed pressure at a working site for forming a container-like formed body; and
digging a hole at a working site and embedding the formed body in the inside of the hole;
wherein the embedded formed body is structurally capable of retaining water and structurally capable of being broken by a force of a root of a plant growing within the embedded container.

12. A method for making a civil engineering material comprising the steps of;
loosening the agglomerates of the civil engineering material of claim 3 at least once;
loading the material in a frame and curing again the material by applying a prescribed pressure at a working site for forming a container-like formed body; and
digging a hole at a working site and embedding the formed body in the inside of the hole;
wherein the embedded formed body is structurally capable of retaining water and structurally capable of being broken by a force of a root of a plant growing within the embedded container.

13. The method form making the civil engineering material according to claim 6, wherein the working site is a desert.
